(19) United States
(12) Patent Application Publication
(10) Pub. No.: US 2014/0105800 A1
(43) Pub. Date: Apr. 17, 2014

(54) METHOD FOR PROCESSING A POWER PLANT FLUE GAS

(71) Applicant: ALSTOM TECHNOLOGY LTD, Baden (CH)

(72) Inventors: Nareshkumar Bernard Handagama, Knoxville, TN (US); Rameshwar Hiwale, Knoxville, TN (US); Sanjay Kumar Dube, Knoxville, TN (US); David James Muraskin, Knoxville, TN (US); Jurgen Dopatka, Knoxville, TN (US); Donald Borio, Knoxville, TN (US)

(73) Assignee: ALSTOM TECHNOLOGY LTD, Baden (CH)

(21) Appl. No.: 13/837,919

(22) Filed: Mar. 15, 2013

Related U.S. Application Data
(60) Provisional application No. 61/617,778, filed on Mar. 30, 2012.

(51) Int. Cl. B01D 53/62; F01N 3/20; B01D 53/56

(52) U.S. Cl. CPC B01D 53/62; B01D 53/565; F01N 3/2066
USPC 423/220; 422/169

(57) ABSTRACT

A method and a system are provided for processing a gas stream wherein the gas stream is passed through an absorption process thereby forming and CO2-lean gas stream having ammonia therein and a CO2-rich stream. The CO2-lean gas stream having ammonia therein subsequently is passed to a selective catalytic reduction process.

### CROSS-REFERENCE TO RELATED APPLICATION

This application claims the benefit of U.S. Provisional Patent Application Ser. No. 61/617,778; filed on Mar. 30, 2012, which is incorporated herein by reference in its entirety.

### FIELD

The present disclosure is generally directed to apparatus and methods for reducing nitrogen oxides and carbon dioxide emissions from fossil fuel used in power generation. In particular, the present disclosure is directed to processes that provide for selective catalytic reduction and carbon capture and storage for reducing nitrogen oxides and carbon dioxide emissions. More particularly, the present disclosure provides a new and useful technique for first processing a flue gas for carbon dioxide emission reduction followed downstream by subsequently processing the flue gas for nitrogen oxides emission reduction.

### BACKGROUND

A number of power generation stations combust fossil fuels such as coal and natural gas to produce electricity. The heat energy of combustion is converted into mechanical energy and then into electricity. Combustion emissions, commonly referred to as a flue gas, are released into the atmosphere. Such combustion emissions may comprise nitrogen oxides (“NOₓ”) and carbon dioxide (“CO₂”), as well as traces of other pollutants and particulate matter. Electricity generation using carbon-based fuels is responsible for a large fraction of the NOₓ and CO₂ emissions worldwide.

One technology for reducing NOₓ emissions from fossil fuel used in power generation is selective catalytic reduction (“SCR”) whereby NOₓ is converted with the aid of a catalyst into nitrogen (“N₂”) and water (“H₂O”). A gaseous reducing agent such as ammonia (“NH₃”) is passed into a stream of flue gas and the NO reduction reaction takes place as the stream of flue gas passes through the catalyst chamber of an SCR unit. Depending upon the reducing agent selected, CO₂ may be released as a reaction product.

A technology for reducing CO₂ emissions from fossil fuel used in power generation is carbon capture and storage (“CCS”). Carbon dioxide emissions are controlled and captured at the point of generation, stored and transported for sequestration, and thereby prevented from being released into the atmosphere. Unfortunately, CCS consumes a high percentage of the power generated at the particular source.

Known solvent-based CO₂ capture technologies for reducing CO₂ emissions from a coal-fired or natural gas-fired boiler flue gas carry an inventory of a solvent circulating through a loop. A CO₂ absorber provides for the chemical absorption of gaseous CO₂ into the solvent from a mixed-stream flue gas. The CO₂ absorber is operated under certain conditions including ranges of temperature and pressure, turbulence, and inter-phase mixing. Subsequently, a CO₂-rich solvent stream is conditioned appropriately and is conveyed to a desorber, regenerator, and optionally a stripper thereby establishing an environment conducive to CO₂ removal. In the regenerator, the solvent is subjected to an elevated temperature, in the range of about 300°-320° F. bottom temperature and 160°-200° F. top temperature, whereas in the absorber the solvent is exposed to a lower temperature environment.

As a result of high ammonia vapor pressure, an aqueous ammonia solvent releases gaseous ammonia in the absorber final stage as carry over, continuously at levels from about 7,000 to 15,000 parts per million (“ppm”). Typically, an ammonia effluent stream from the absorber final stage is captured in a two-stage water wash system. First, a water wash is employed to capture the ammonia by absorption in a separate water loop; and second, the ammonia-rich water is steam-stripped in an additional stripper. Accordingly, the ammonia is recovered and recycled for subsequent use in the CO₂ absorber. The described method for ammonia recovery and recycle is operationally cumbersome and intensely increases the capital expense and the operating expense of a power plant.

### SUMMARY

According to aspects illustrated herein, there is provided a method for processing a gas stream comprising: passing the gas stream through an absorption process thereby forming and CO2-lean gas stream having ammonia therein and a CO2-rich stream; and passing the CO2-lean gas stream having ammonia therein to a selective catalytic reduction process.

According to other aspects illustrated herein, there is provided a system for treating a gas stream comprising: an absorber wherein the gas stream is treated therein thereby forming and CO2-lean gas stream having ammonia therein and a CO2-rich stream; and a selective catalytic reduction unit wherein the CO2-lean gas stream having ammonia therein is received from the absorber at least a portion of the ammonia is consumed by the selective catalytic reduction unit.

The above described and other features are exemplified by the following features and detailed description.

### BRIEF DESCRIPTION OF THE DRAWINGS

Referring now to the figures, which are exemplary embodiments, and wherein the like elements are numbered alike:

FIG. 1 provides a block diagram of a prior art configuration of an arrangement of power plant flue gas processing equipment.

FIG. 2 provides a block diagram of a configuration of an arrangement of power plant flue gas processing equipment in accordance with the present disclosure.

FIG. 3 provides a block diagram of a prior art configuration of a chilled ammonia process for carbon capture and storage.

FIG. 4 provides a block diagram of a chilled ammonia process for carbon capture and storage in accordance with the present disclosure.

### DETAILED DESCRIPTION

The method of the present disclosure combines processes for reducing NOx and CO₂ emissions from fossil fuel used in power generation. The present disclosure comprises the use of SCR and CCS for reducing NOx and CO₂ emissions. A particularly new and useful technique of the method comprises first processing a flue gas for CO₂ emission reduction and then processing the flue gas for NOₓ emission reduction. In one embodiment, the method comprises passing the flue gas stream from a CCS process to an SCR process wherein the flue gas stream from the CCS process includes excess ammonia. Thus, it is no longer necessary to inject and mix a separate ammonia stream with a flue gas stream from a combustion unit, such as a boiler, to provide for effective operation of the SCR process. The NOₓ reduction reaction takes place as the effluent stream from the CCS passes through the catalyst chamber of the SCR process.

The method of the present disclosure features a CCS referred to as a chilled ammonia process (“CAP”). This process can consume a lower percentage of the power generated at a particular source than other CCS technologies. The CAP also provides for the regeneration of a reagent thereby resulting in low reagent consumption costs. Moreover, an ammonium sulfate byproduct stream of the CAP may be used commercially as, for example, fertilizer, and a high-purity CO₂ product stream contains low moisture and ammonia at elevated pressure thereby resulting in reduced CO₂ compression costs. Emissions from the CAP include gaseous ammonia. By passing an effluent stream from the CAP to an SCR unit, the gaseous ammonia released by the CAP is passed to the SCR unit as a primary ammonia reducing agent for further reducing NOx emissions. By incorporating both CAP and SCR technologies wherein the effluent from the CAP is passed to the SCR unit, a number of components that typically comprise CAP are eliminated and SCR is concurrently effectively enhanced.

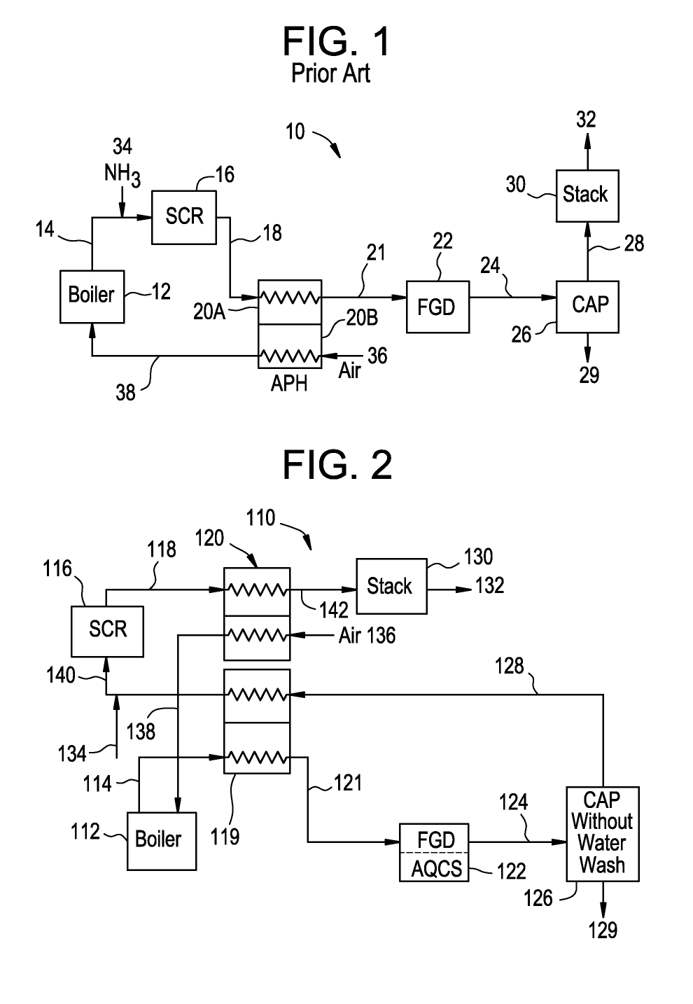

As depicted in FIG. 1, an arrangement 10 of typical prior art power plant flue gas processing equipment comprises a combustion unit, such as for example, a boiler 12 wherein a flue gas stream 14 passes from the boiler 12 into an SCR unit 16 at high temperature. An SCR unit effluent stream 18 passes from the SCR unit 16 and through a first section 20A of a heat exchange unit or an air pre-heater (“APH”) and then, in turn, an APH effluent stream 21 passes into a flue gas desulfurization (“FGD”) system or unit 22 for the reduction of sulfur dioxide emissions. In conditions with high levels of sulfur trioxide (“SO₃”), one or more units for SO₃ mitigation are installed to minimize corrosion of flue gas path components and to reduce fine particulate matter. In the arrangement 10, a FGD system effluent stream 24 is passed into a CCS process, such as for example, a CAP 26. A first CAP effluent stream 28 is released into the atmosphere via a stack 30 as a power plant emission stream 32. A second CAP effluent stream 29 comprising a CO₂ product stream is provided for further processing such as, for example, CO₂ sequestration. For effective SCR operation, an NH₃ stream 34 may be admixed with the flue gas stream 14 from the boiler 12 prior to entering the SCR unit 16. For efficient boiler operation, an air stream 36 may be passed through a second section 20B of the APH prior to entering the boiler 12 as a pre-heated air stream 38.

In contrast and as depicted in FIG. 2, an arrangement 110 of power plant flue gas processing equipment in accordance with the present disclosure comprises a boiler 112 wherein a flue gas stream 114 passes from the boiler 112 into a first APH 119. The arrangement 110 may comprise one APH having a plurality of heat exchange sections or it may comprise a plurality of separate heat exchange units. An effluent stream 121 is passed from the first APH 119 into an FGD unit 122. In addition to passing the effluent stream 121 into the FGD unit 122, the effluent stream 121 may be passed through one or more additional units of an Air Quality Control System (“AQCS”) for control and/or removal of particulates from the effluent stream 121. Such particulates may include, for example: sulfur oxides (“SOx”); acidic compounds including, but not limited to, hydrogen chloride and hydrogen fluoride; and heavy metals including, but not limited to, mercury, cadmium, lead, and chromium. In addition, the AQCS unit(s) may be placed upstream of the FGD, downstream of the FGD, or may be integrally formed with the FGD.

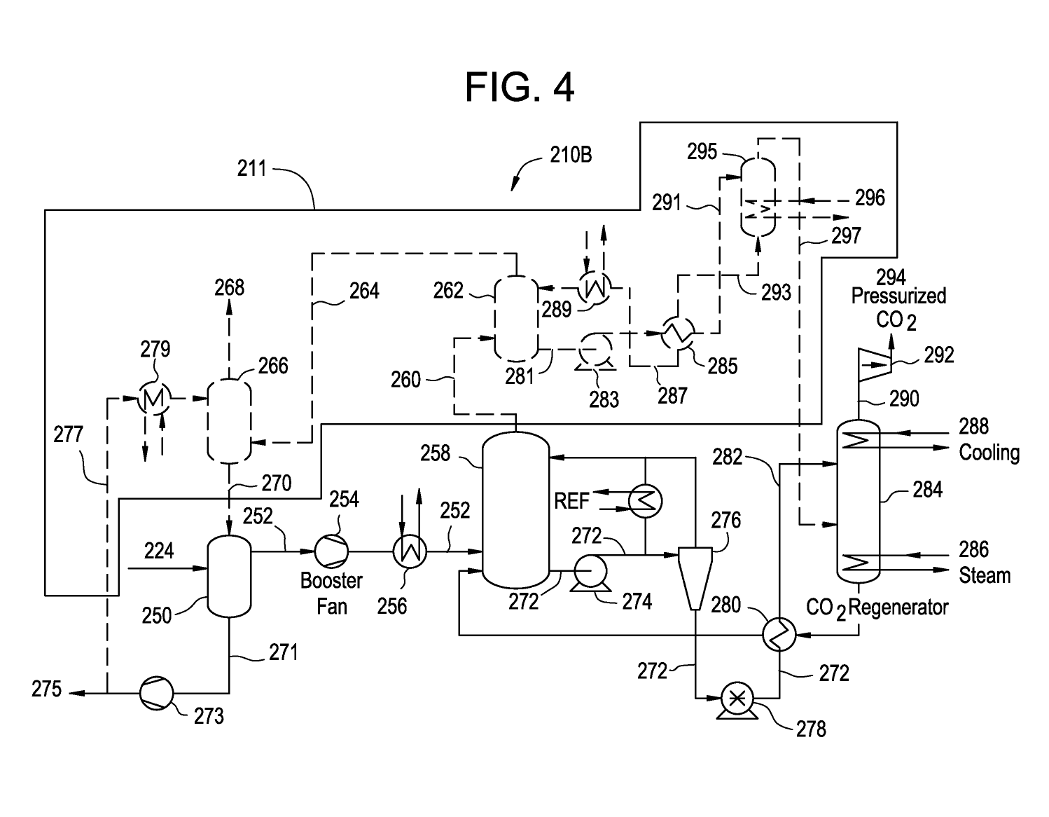

A FGD unit effluent stream 124 is passed into a CAP 126 that no longer comprises the water wash components (for example, the modified CAP 210B of FIG. 4). A first CAP effluent stream 128 comprising a clean flue gas with ammonia is passed to the first APH 119. A second CAP effluent stream 129 comprising a CO₂ product stream is provided for further processing such as, for example, CO₂ sequestration. The first CAP effluent stream 128 is heated thereby forming an APH effluent stream 140, while the flue gas stream 114 is concurrently cooled thereby forming the effluent stream 121, when passing through the first APH 119. The APH effluent stream 140 having a temperature in the range of about 600° F. to about 700° F. is passed into an SCR unit 116. An SCR unit effluent stream 118 having a temperature in the range of about 600° F. to about 700° F. is passed through a second APH 120. For efficient boiler operation, an air stream 136 may be passed through the second APH 120 prior to entering the boiler 112 as a pre-heated air stream 138. The SCR effluent stream 118 is cooled thereby forming an APH effluent stream 142, while the air stream 136 is concurrently heated thereby forming the pre-heated air stream 138 when passing through the second APH 120. Wherein other pollutants have already been removed, the APH effluent stream 142 having a temperature in the range of about 100° F. to about 200 ° F. is released into the atmosphere via a stack 130 as a power plant emission stream 132.

As described above, the first CAP effluent stream 128 comprising a clean flue gas with ammonia is ultimately passed to the SCR unit 116 as APH effluent stream 140. The stream 140 comprises the primary ammonia reducing agent provided to the SCR unit 116 and is sufficient for processing the gas stream passing therethrough and forming the SCR effluent stream 118. As a result, there is no need for a separate NH₃ stream to be provided to the SCR unit 116. Optionally, a secondary NH₃ stream 134 may be admixed with the effluent stream 140 prior to entering the SCR unit 116. While the secondary NH₃ stream 134 is described as being admixed with the effluent stream 140, the present invention is not limited in this regard as the secondary NH₃ stream 134 may be selectively injected at any location upstream of the SCR unit 116, or directly into the SCR unit 116, without departing from the broader aspects of the present invention.

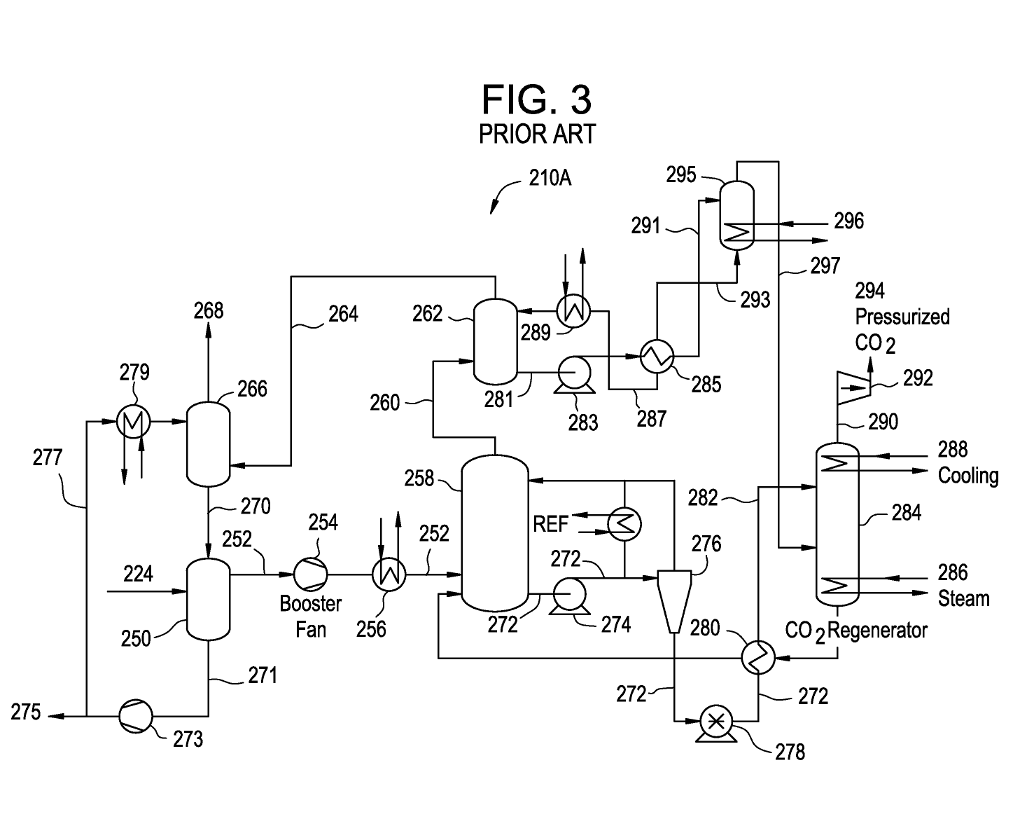

In one embodiment, CAP 126 comprises cooling the flue gas effluent stream, absorbing CO₂ and regenerating the reagent used to absorb the CO₂. The above-described arrangement of power plant flue gas processing equipment 110 provides for new and useful improvements to CAP as well. An arrangement of a typical prior art CAP 210A is provided in FIG. 3. An arrangement of a modified CAP 210B in accordance with the present disclosure is provided in FIG. 4 in comparison to the prior art arrangement provided in FIG. 3.

As depicted in FIG. 3, a flue gas effluent stream 224 is passed from the FGD system (e.g., the FGD system 22 of FIG. 1) to a first direct contact cooler (“DCC”) 250, such as for example a cooling tower or a mechanical chiller. For example, direct cooling of flue gas effluent stream 224 results in the condensation of water and in the capture of residual contaminants. The low temperature and the elimination of most of the moisture from flue gas effluent stream 224 results in a substantial reduction in volume and mass of flue gas effluent stream 224 thereby reducing the size of downstream equipment.

A gas effluent stream 252 passes from the first DCC 250 through a booster fan 254, is cooled via a refrigeration unit 256, and then is passed to a CO₂ absorber 258 which is designed to operate with a solution or with a slurry. Within the CO₂ absorber 258, the CO₂ in the flue gas effluent stream reacts with an ammonium carbonate solution to form ammonium bicarbonate. The flue gas effluent stream flows upward in a counter-current direction to the flow of the solution within the CO₂ absorber 258. A gas effluent stream 260 is passed from the CO₂ absorber 258 to a water wash unit 262 where excess ammonia is captured by a cold-water wash. A gas effluent stream 264 is passed from the water wash unit 262 to a second DCC 266 and a clean combustion gas stream 268 is released into the atmosphere via a stack. A water-based effluent stream 270 containing the captured ammonia is passed from the second DCC 266 to the first DCC 250 and ultimately the captured ammonia is returned to CO₂ absorber 258. A water-based effluent stream 271 may be discharged from the first DCC 250 via a valve 273 as a bleed solution 275 or may be passed as a water-based effluent stream 277 through a cooling unit 279 and returned to the second DCC 266.

A CO₂-rich slurry 272 that comprises ammonium bicarbonate is passed from CO₂ absorber 258, is pumped via a pump 274 through a separator 276 and subsequently is pumped via a pump 278 through a heat exchanger 280. Optionally, the separator 276 may be eliminated from the process wherein ammonium bicarbonate solids are no longer generated if the scrubbing medium is a solution and not a slurry. With the required amount of heat, the ammonium bicarbonate solids are dissolved with eventual evolution of ammonia, water, and carbon dioxide gases. Accordingly, the ammonium bicarbonate in the CO₂-rich slurry dissolves as the temperature increases in heat exchanger 280 and CO₂-rich slurry 272 turns into a clear hot solution 282. The hot solution 282 is injected into a high-pressure regenerator 284 that operates as a distillation column. Additional heat for stripping the CO₂ from the slurry may be provided from a source of steam 286. A source of cooling 288 may be provided for a CO₂ product stream 290 before being compressed via a compressor 292 and removed from the system as a pressurized CO₂ stream 294. The CO₂ product stream 294 is passed from high-pressure regenerator 284 at a higher pressure than other CO₂ processes thereby resulting in fewer stages of downstream CO₂ compression equipment.

Water wash unit 262 captures both ammonia and water vapor from the gas effluent stream 260 passing from the CO₂ absorber 258. A water-based effluent stream 281 is pumped via a pump 283 through a heat exchanger 285. Ammonia and water reaction products are stripped and condensed from the water-based effluent stream 281 for use as a reagent and a flue gas wash solvent, respectively. A first water-based effluent stream 287 passing from the heat exchanger 285 is condensed via a refrigeration unit 289 and is returned to water wash unit 262. A second water-based effluent stream 291 and a third water-based effluent stream 293 passing from heat exchanger 285 are passed to a stripper unit 295 where additional heat for stripping CO₂ from third water-based effluent stream 293 may be provided from a source of steam 296. A CO₂ stream 297 is passed from the stripper unit 295 to the high-pressure regenerator 284.

In contrast to the arrangement of the typical prior art CAP 210A as provided in FIG. 3, an arrangement of a modified CAP 210B in accordance with the present disclosure is provided in FIG. 4. By advantageously passing the effluent stream comprising a clean flue gas and ammonia from the CAP to the SCR unit as shown in FIG. 2, all of the features contained within encircled area 211 may be eliminated from CAP 210A, as shown in FIG. 4, thereby resulting in an improved, efficient and effective modified CAP 210B. All of the water wash components as represented within encircled area 211 may be eliminated from CAP 210A. The gas effluent stream 260 contains excess ammonia and the process of capturing such excess ammonia by a cold-water wash may be eliminated as the gas effluent stream 260 is provided directly to the SCR unit. The gaseous ammonia released by the CAP is passed to the SCR unit as the primary ammonia reducing agent for reducing NOx emissions.

As should be appreciated, the arrangement of power plant flue gas processing equipment in accordance with the present disclosure provides for the capture of ammonia slip, or fugitive ammonia, from one or more CO₂ absorber(s) for utilization as the supplemental ammonia reagent for an SCR unit thereby providing the NOx reducing treatment agent for the SCR unit. Accordingly, the arrangement of power plant flue gas processing equipment in accordance with the present disclosure also provides for mitigating ammonia emissions. The disclosed process provides for a constant ammonia capacity within the overall process such that injection of ammonia into the SCR unit also may be eliminated or substantially minimized. The dedicated purchase of ammonia reagent to capture NOx is no longer required thereby substantially reducing the operating cost of the SCR unit. The disclosed process minimizes the overall ammonia consumption of the power plant and reduces the reagent storage requirements on site. The ammonia feed system and associated ammonia grids may be eliminated thereby reducing the size of the SCR unit required. Therefore, the disclosed process reduces both the capital and the operating cost of the power plant related to the use of ammonia.

External reheating also may be eliminated as the APH can include a second stage. The increased capital and operating costs associated with the APH heat exchanger and ductwork from the CAP can be reduced using sorbent injection equipment upstream of a wet-type FGD to reduce sulfur oxide, particularly SO₃, from the flue gas. The additional SO₃ mitigation equipment is desired to avoid higher grade materials of construction of the APH and ductwork from the CAP. The likelihood of SO₃ present in the flue gas downstream of CAP is high due to difficulties in achieving SO₃ capture in typical wet type FGD and within the CAP.

In accordance with the disclosed process, the SCR unit may be operated at a lower temperature as the formation of ammonium sulfate is not possible because the SCR unit is located downstream of the CAP process. This further reduces the operating cost of the power plant and also increases the overall efficiency of the power plant. A further benefit is realized whereby the majority of the heavy metals will be captured in the AQCS system, and wherein the SCR unit is located downstream of the CAP process, the SCR unit will not receive these heavy metal. Accordingly, the catalyst deactivation/poisoning due to these heavy metals is substantially minimized thereby increasing the catalyst life within the SCR process. This provides for a significant reduction in the operating cost of the SCR process.

The CAP water wash process components as well as the ammonia stripper components for ammonia recovery and recycle may be eliminated or substantially minimized. The ammonium sulfate byproduct and its associated equipment such as crystallizers, tanks, pumps, etc., can be eliminated. Residual sulfur oxides emitted from the FGD may be captured in the DCC by using caustic/lime and the byproduct may be processed through the FGD byproduct. In addition, the requirement for the use sulfuric acid may be eliminated as there is no longer a need to capture the ammonia slip from the CAP process. A heat exchanger and one stage of direct contact cooling also may be eliminated. Such an elimination or reduction in process components reduces the foot print of the overall system as well as the capital, operating and maintenance expenses of the overall system.

The various embodiments of the present invention described herein above provide a method for processing a gas stream comprising: passing the gas stream through an absorption process thereby forming and CO2-lean gas stream having ammonia therein and a CO2-rich stream; and passing the CO2-lean gas stream having ammonia therein to a selective catalytic reduction process. The gas stream may comprise a flue gas stream. In one embodiment, the selective catalytic reduction process is positioned downstream of the absorption process. Preferably, the CO2-lean gas stream having ammonia therein is passed from the absorption process directly to the selective catalytic reduction process while not having passed through a water wash process. Optionally, the CO2-lean gas stream having ammonia therein is heated prior to passing the CO2-lean gas stream to the selective catalytic reduction process. In addition, the gas stream preferably is processed in one or more units of an Air Quality Control System for removal of particulates therefrom prior to passing the gas stream through the absorption process.

The various embodiments of the present invention described herein above also provide a system for treating a gas stream comprising: an absorber wherein the gas stream is treated therein thereby forming and CO2-lean gas stream having ammonia therein and a CO2-rich stream; and a selective catalytic reduction unit wherein the CO2-lean gas stream having ammonia therein is received from the absorber at least a portion of the ammonia is consumed by the selective catalytic reduction unit. The system may comprise a combustion unit having an effluent that is provided to the absorber as the gas stream. In one embodiment, the selective catalytic reduction unit is positioned downstream of the absorber. Preferably, the CO2-lean gas stream having ammonia therein is passed from the absorber directly to the selective catalytic reduction unit while not having passed through a water wash. Optionally, a heat exchange unit is positioned between the absorber and the selective catalytic reduction unit wherein the CO2-lean gas stream having ammonia therein is heated. In addition, one or more units of an Air Quality Control System preferably are positioned upstream of the absorber for removal of particulates from the gas stream.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for processing a gas stream comprising:
passing the gas stream through an absorption process thereby forming and CO2-lean gas stream having ammonia therein and a CO2-rich stream; and
passing the CO2-lean gas stream having ammonia therein to a selective catalytic reduction process.

2. The method for processing a gas stream of claim 1 wherein the gas stream comprises a flue gas stream.

3. The method for processing a gas stream of claim 1 wherein the selective catalytic reduction process is positioned downstream of the absorption process.

4. The method for processing a gas stream of claim 1 wherein the CO2-lean gas stream having ammonia therein is passed from the absorption process directly to the selective catalytic reduction process while not having passed through a water wash process.

5. The method for processing a gas stream of claim 1 wherein the CO2-lean gas stream having ammonia therein is heated prior to passing the CO2-lean gas stream to the selective catalytic reduction process.

6. The method for processing a gas stream of claim 1 wherein the gas stream is processed in one or more units of an Air Quality Control System for removal of particulates therefrom prior to passing the gas stream through the absorption process.

7. A system for treating a gas stream comprising:
an absorber wherein the gas stream is treated therein thereby forming and CO2-lean gas stream having ammonia therein and a CO2-rich stream; and
a selective catalytic reduction unit wherein the CO2-lean gas stream having ammonia therein is received from the absorber at least a portion of the ammonia is consumed by the selective catalytic reduction unit.

8. The system for treating a gas stream of claim 7 further comprising a combustion unit having an effluent that is provided to the absorber as the gas stream.

9. The system for treating a gas stream of claim 7 wherein the selective catalytic reduction unit is positioned downstream of the absorber.

10. The system for treating a gas stream of claim 7 wherein the CO2-lean gas stream having ammonia therein is passed from the absorber directly to the selective catalytic reduction unit while not having passed through a water wash.

11. The system for treating a gas stream of claim 7 further comprising a heat exchange unit positioned between the absorber and the selective catalytic reduction unit wherein the CO2-lean gas stream having ammonia therein is heated.

12. The system for treating a gas stream of claim 7 further comprising one or more units of an Air Quality Control System positioned upstream of the absorber for removal of particulates from the gas stream.
